(19) United States
(12) Patent Application Publication
(10) Pub. No.: US 2023/0209456 A1
(43) Pub. Date: Jun. 29, 2023

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Youping ZHAO, Beijing (CN); Ziqing DONG, Beijing (CN); Chen SUN, Beijing (CN); Zhong TIAN, Beijing (CN)

(73) Assignee: Sony Group Corporation, Tokyo (JP)

(21) Appl. No.: 17/795,873

(22) PCT Filed: Mar. 10, 2021
(86) PCT No.: PCT/CN2021/079891

§ 371 Date: Mar. 1, 2023

(30) Foreign Application Priority Data
Mar. 17, 2020 (CN) 202010188245.7

(51) Int. Cl. H04W 48/20; H04L 12/14; H04W 48/02

(52) U.S. Cl. CPC H04W 48/20; H04L 12/1407; H04W 48/02

(57) ABSTRACT

Provided are an electronic device and method for wireless communication, and a computer-readable storage medium. The electronic device comprises: a processing circuit, which is configured to: determine the resource price of a base station on the basis of a comparison between an overall wireless resource demand of a user equipment accessed by a base station in a predetermined area and a radio resource that can be provided by the base station; and send the resource price of the base station to the base station, such that the user equipment determines, at least on the basis of the resource price, whether to access the base station.

This application claims priority to Chinese Patent Application No. 202010188245.7, titled “ELECTRONIC DEVICE AND METHOD FOR WIRELESS COMMUNICATION, AND COMPUTER-READABLE STORAGE MEDIUM”, filed on Mar. 17, 2020 with the China National Intellectual Property Administration, which is incorporated herein by reference in its entirety.

### FIELD

The present disclosure relates to the technical field of wireless communications, and in particular to a spectrum management technology. More specifically, the present disclosure relates to an electronic apparatus and a method for wireless communications, and a computer-readable storage medium.

### BACKGROUND

With the rapid development of wireless technology, the quantity of user equipment continues to increase, and spectrum resources become more and more scarce. How to use limited spectrum resources to satisfy massive connection requirements has become an urgent problem to be solved. Various solutions have been proposed to solve this problem, such as establishing highly dense cells, and using super-large antenna arrays. These methods require construction of new base stations or reforming of existing base stations, which incurs a high contruction cost and the system capacity is still limited by the spectrum resources of the base station.

In addition, various spectrum management methods may be adopted to improve spectrum utilization efficiency. A spectrum management algorithm may be obtained based on various models such as game theory models, social networks, intelligent algorithms, and the like. Different spectrum management algorithms may have different advantages.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

According to an aspect of the present disclosure, an electronic apparatus for wireless communications is provided. The electronic apparatus includes processing circuitry configured to: determine, based on a comparison between an overall wireless resource requirement of user equipment (UE) accessed in a base station within a predetermined region and wireless resources that the base station is capable of providing, a resource price of the base station; and transmit, to the base station, the resource price of the base station, so that the UE determines whether to access the base station based on at least the resource price.

According to another aspect of the present disclosure, a method for wireless communications is provided. The method includes: determining, based on a comparison between an overall wireless resource requirement of user equipment (UE) accessed in a base station within a predetermined region and wireless resources that the base station is capable of providing, a resource price of the base station; and transmitting, to the base station, the resource price of the base station, so that the UE determines whether to access the base station based on at least the resource price.

According to an aspect of the present disclosure, an electronic apparatus for wireless communications is provided. The electronic apparatus includes processing circuitry configured to: acquire, from UE accessed in a base station, an overall wireless resource requirement of the UE; provide, to a spectrum management device, information of a comparison between the overall wireless resource requirement of the UE and wireless resources that the base station is capable of providing; acquire, from the spectrum management device, a resource price of the base station determined by the spectrum management device based on the information as well as the resource price of another base station determined by the spectrum management device; and provide information of the resource price to the UE accessed in the base station.

According to another aspect of the present disclosure, a method for wireless communications is provided. The method includes: acquiring, from UE accessed in a base station, an overall wireless resource requirement of the UE; providing, to a spectrum management device, information of a comparison between the overall wireless resource requirement of the UE and wireless resources that the base station is capable of providing; acquiring, from the spectrum management device, a resource price of the base station determined by the spectrum management device based on the information as well as the resource price of another base station determined by the spectrum management device; and providing information of the resource price to the UE accessed in the base station.

According to an aspect of the present disclosure, an electronic apparatus for wireless communications is provided. The electronic apparatus includes processing circuitry configured to: acquire, from a first base station which UE is currently requesting to access or accessed in, information of a resource price of the first base station and the resource price of each base station within a set of candidate base stations, where the UE is capable of accessing the base station within the set of candidate base stations, and the resource price is determined based on information of a comparison between an overall wireless resource requirement of the UE for a base station and wireless resources that the base station is capable of providing; and determine, based on at least the resource price, a second base station to access from among the set of candidate base stations, where the resource price of the second base station is lower than the resource price of the first base station.

According to another aspect of the present disclosure, a method for wireless communications is provided. The method includes: acquiring, from a first base station which UE is currently requesting to access or accessed in, information of a resource price of the first base station and the resource price of each base station within a set of candidate base stations, where the UE is capable of accessing the base station within the set of candidate base stations, and the resource price is determined based on information of a comparison between an overall wireless resource requirement of the UE for a base station and wireless resources that the base station is capable of providing; and determining, based on at least the resource price, a second base station to access from among the set of candidate base stations, where the resource price of the second base station is lower than the resource price of the first base station.

With the electronic apparatus and method according to the above-mentioned aspects of the present disclosure, a resource price of a base station may be determined by considering a comparison between a wireless resource providing capability of the base station and a wireless resource requirement of user equipment for the base station, and the resource price is provided to the base station, so that the user equipment can dynamically select to access the base station with a lower resource price, and thereby a total quantity of user equipment accessed in a given region is increased, and thus a spectrum utilization efficiency is improved.

According to other aspects of the present disclosure, there are further provided computer program codes and computer program products for implementing the methods for wireless communications above, and a computer readable storage medium having recorded thereon the computer program codes for implementing the methods for wireless communications described above.

These and other advantages of the present disclosure will be more apparent from the following detailed description of preferred embodiments of the present disclosure in conjunction with the accompanying drawings.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 shows an example of a scenario where user equipment are distributed unevenly;

FIG. 2 is a block diagram showing functional modules of an electronic apparatus for wireless communications according to an embodiment of the present disclosure;

FIG. 3 is a block diagram showing functional modules of an electronic apparatus for wireless communications according to an embodiment of the present disclosure;

FIG. 4 is a diagram showing an example of a set of candidate base stations;

FIG. 5 is a block diagram showing functional modules of an electronic apparatus for wireless communications according to another embodiment of the present disclosure;

FIG. 6 is a block diagram showing functional modules of an electronic apparatus for wireless communications according to another embodiment of the present disclosure;

FIG. 7 shows an example of a related information procedure among a spectrum management device, base stations and user equipment;

FIG. 8 shows another example of a related information procedure among a spectrum management device, base stations and user equipment;

FIG. 9 shows a schematic diagram of a scenario of a simulation example;

FIG. 10 shows an example in which a simulated region is divided into three parts;

FIG. 11 is a graph showing a comparison between the solution of the present disclosure and a conventional solution in terms of total access amount of user equipment;

FIG. 12 is a graph showing performance comparison of a dynamic pricing scheme versus a static pricing scheme;

FIG. 13 is a schematic diagram showing an example of tiered pricing;

FIG. 14 is a graph showing effects of different number of tiers of the tiered pricing on a total access amount of user equipment;

FIG. 15 shows a flowchart of a method for wireless communications according to an embodiment of the present disclosure;

FIG. 16 shows a flowchart of a method for wireless communications according to another embodiment of the present disclosure;

FIG. 17 shows a flowchart of a method for wireless communications according to another embodiment of the present disclosure;

FIG. 18 is a block diagram showing an example of an exemplary configuration of a server to which the technology of the present disclosure may be applied;

FIG. 19 is a block diagram showing a first example of an exemplary configuration of an eNB or gNB to which the technology of the present disclosure may be applied;

FIG. 20 is a block diagram showing a second example of an exemplary configuration of an eNB or gNB to which the technology of the present disclosure may be applied;

FIG. 21 is a block diagram showing an example of an exemplary configuration of a smartphone to which the technology of the present disclosure may be applied;

FIG. 22 is a block diagram showing an example of an exemplary configuration of a car navigation device to which the technology of the present disclosure may be applied; and

FIG. 23 is a block diagram of an exemplary block diagram illustrating the structure of a general purpose personal computer capable of realizing the method and/or device and/or system according to the embodiments of the present disclosure.

### DETAILED DESCRIPTION

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a service, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

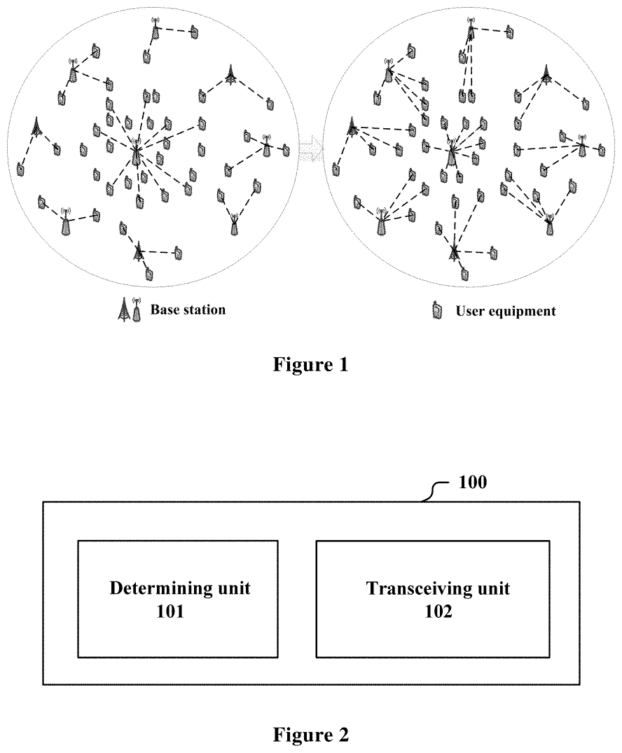

In regions with high population density, some base stations suffer from shortage of spectrum while other base stations has idle spectrum not used. FIG. 1 shows an example of a scenario in which user equipment (UE) are distributed unevenly. For example, in prosperous commercial streets or district with a huge flow of visitors, some base stations (BSs) have too many UE accesses due to the uneven distribution of UEs, and eventually have no available channels and therefore no more connections can be established; meanwhile, some base stations have too few UE accesses, and therefore the spectrum resources are not fully utilized. A base station with a huge demand for UE accesses may result in shortage of spectrum for the base station, and the base station with small demand for UE accesses may result in waste of spectrum for the base station. In order to utilize spectrum resources more effectively, an electronic apparatus 100 is provided in an embodiment for spectrum resource management in wireless communications. It should be understood that although the scenario of FIG. 1 is described here, the embodiment is not limited to thereto, and may be applied to various scenarios for spectrum management.

FIG. 2 shows a block diagram of functional modules of an electronic apparatus 100 for wireless communications according to an embodiment of the present disclosure. As shown in FIG. 2, the electronic apparatus 100 includes a determining unit 101 and a transceiving unit 102. The determining unit 101 is configured to determine a resource price of a base station based on a comparison between an overall wireless resource requirement of UE accessed in a base station within a predetermined region and wireless resources that the base station can provide. The transceiving unit 102 is configured to transmit the resource price of the base station to the base station, so that the UE determine whether to access the base station based on at least the resource price.

For example, the electronic apparatus 100 may be provided on a central management device side or a spectrum management device side, or may be communicatively connected to a central management device or a spectrum management device. In addition, the electronic apparatus 100 may be provided on a core network side. The central management device or spectrum management device described herein may be implemented as various functional entities, such as a Spectrum Access System (SAS), a Coesxitence Manager (CxM), a Group Spectrum Coordinator (GSC).

It should be noted that the electronic apparatus 100 may be implemented at a chip level or a device level. For example, the electronic apparatus 100 may function as a central management device or a spectrum management device itself, and may include external devices such as a memory and a transceiver (not shown). The memory may be configured to store programs required for the central management device or the spectrum management device to perform various functions and related data information. The transceiver may include one or more communication interfaces to support communications with different devices (such as a base station, another central management device or spectrum management device, and user equipment). Implementation of the transceiver is not specifically limited herein.

In the embodiment, the spectrum management device sets a price for spectrum resources of each base station, and performs spectrum management based on the price, in order to guide the UE to access base stations uniformly.

In an example, the determining unit 101 determines the resource price of the base station based on a ratio of the overall wireless resource requirement of the UE to a wireless resources supply of the base station, and determines the resource price as being positively correlated to the ratio. Specifically, a larger value of the ratio of the overall wireless resource requirement of the UE to the wireless resources supply of the base station indicates that it is more difficult for the base station to meet the overall wireless resource requirement of the UE, and it tends to prevent the UE from selecting the base station for access but to distribute the UE to another base station, and therefore the resource price of the base station is determined to be a high value.

For example, the wireless resource requirement may include one or more of the following: a spectrum requirement, a delay requirement, a reliability requirement, a transmission rate requirement, and the like. The spectrum requirement may be taken as an example and explained in the description below, but it should be understood that this is not limiting. For example, regarding the delay requirement, the determining unit 101 may determine a higher resource price for the base station that can provide a longer delay, so as to guide UE to access the base station that provides low-delay service.

The transceiving unit 102 is further configured to obtain, from the base station, one or more of the following: information of the overall wireless resource requirement of the UE accessed in the base station, resource supply information of wireless resources that the base station can provide, location information of the base station, and information of transmission power of the base station. The information is used, for example, for the determining unit 101 to determine the resource price.

In a case that the wireless resource requirement includes a spectrum requirement, for example, the determining unit 101 may determine the resource price of the base station based on equation (1):

$${p}_{i} = k \frac{{\sum }_{j}^{N} {D}_{ij}}{{C}_{i}} \qquad ( 1 )$$

In the equation, pᵢ represents a determined resource price of BS-i, j represents UE-j accessed in BS-i, N represents a total number of UEs accessed in BS-i, and Dᵢⱼ represents an amount of spectrum required by UE-j for BS-i, Σⱼ^{N} Dᵢⱼ represents an overall wireless resource requirement of all UEs accessed in base station BS-i, Cᵢ represents the spectrum supply amount of base station BS-i, and k is a coefficient. A value of Σⱼ^{N} Dᵢⱼ may change as the UE accesses BS-i or disconnects from BS-i, and therefore the resource price of BS-i changes dynamically.

In addition, the UEs accessed in the base station mentioned here may include UE requesting to access the base station. In other words, the wireless resource requirement of UE requesting to access the base station may also be included in the overall wireless resource requirement of UEs of the base station.

The determining unit 101 may be configured to determine the resource price in various forms in addition to the above equation. For example, the resource price may be determined as a step-like function with respect to the ratio, that is, tiered pricing is applied. It may be understood that more tiers may lead to higher accuracy of pricing, thereby obtaining better performance in spectrum management, for example, more UEs may be accessed.

The determining unit 101 determines the resource price for each of base stations in the predetermined region managed by the spectrum management device, and the transceiving unit 102 provides information about the resource price to each of the base stations, where the information may include the price of the base station itself and the resource price of other base stations. The base station provides the received information of the resource price to the UE that the base station is currently serving, for the UE to determine, based on at least the resource price, whether to access the base station or whether to access another base station.

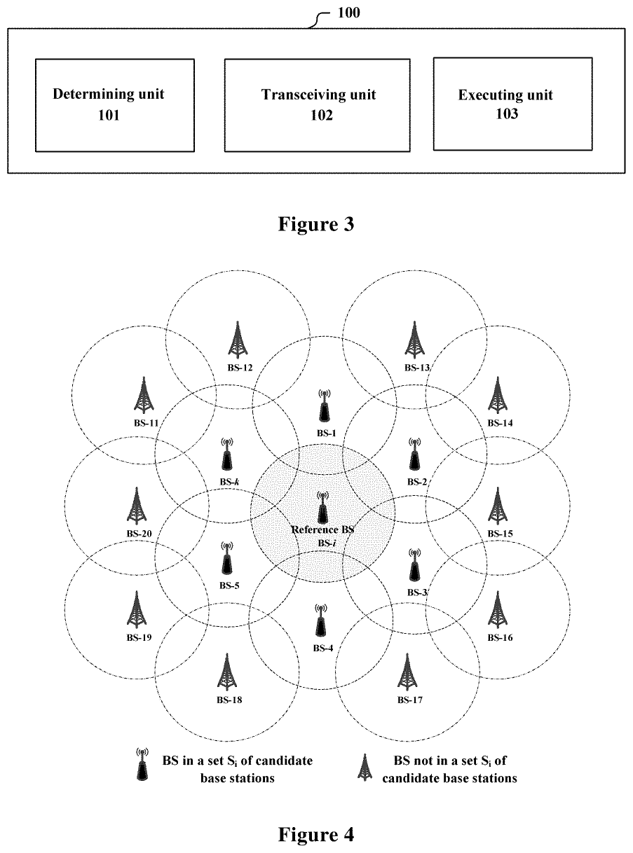

As shown in FIG. 3, the electronic apparatus 100 may further include an executing unit 103 configured to determine, for each base station, a set of candidate base stations of the base station, where the UE accessed in the base station can access a base station among the candidate base stations. In an example, the executing unit 103 may determine a base station of which a coverage range overlaps with that of the base station and which has a capability of providing wireless resources as a base station in the set of candidate base stations. In other words, for a base station, a base station whose coverage range overlaps with the coverage range of the base station and has idle spectrum resources may be determined as a candidate base station of the base station. FIG. 4 shows a schematic diagram of a set of candidate base stations. Taking a reference base station BS-i as an example, base stations in the set of candidate base stations of the base station and base stations not in the set of candidate base stations of the base station are shown in FIG. 4.

For each of the base stations, the transceiving unit 102 provides the base station with the resource price of the base station and the resource price of each base station in the set of candidate base stations for the base station. In this way, the base station provides these resource prices to UE (which may be UE already accessed in the base station or UE requesting to access the base station) of the base station. For example, the UE may determine to access the base station whose resource price is lower. In a case that the resource price of the current base station is the lowest, the UE may remain accessed in the current base station without handover. As for how the UE selects the base station to access will be described in detail hereinafter. When providing the resource price, the transceiving unit 102 may further provide location information or identification information of a corresponding base station, so that the UE can identify the base station.

Since situations such as joining of new UE, disconnection of UE already accessed in, and handover of UE between different base stations based on resource prices may occur, the UEs accessed in each base station may change, and the overall wireless resource requirement of the UEs may change correspondingly, resulting in change in the comparison between the overall wireless resource requirement and the wireless resource supply of the base station, and thereby causing changes in the resource prices of the base stations. Correspondingly, the UE may perform selection of the base station to access again based on the changed resource prices, which again causes change in the comparison and further results in change in the resource prices. This process may be performed iteratively to obtain an optimized spectrum management scheme.

In order to reduce signaling overhead and improve efficiency, for example, the determining unit 101 and the executing unit 103 may be configured to perform, in a case that the change in the comparison between the overall wireless resource requirement and the wireless resource supply for at least one base station reaches a predetermined degree, spectrum management dynamically in response to the change in the comparison. The spectrum management includes, for example, updating the resource prices of the base stations and updating the set of candidate base stations. The predetermined degree may be predetermined by the determining unit 101 or the executing unit 103, depending on, for example, efficiency of spectrum management, signaling overhead, and expected computing load required to be realized.

In an example, each base station performs statistics and determination on changes in the overall wireless resource requirement for the base station, and reports the changed comparison to the spectrum management device in a case that the comparison reaches or exceeds the predetermined degree. For example, under a condition that the amount of wireless resources supplied by the base station remains unchanged, the base station may determine whether the change in the overall wireless resource requirement of the UE exceeds a predetermined threshold, and report the changed overall wireless resource requirement to the spectrum management device in a case of determining that the change exceeds the predetermined threshold.

Correspondingly, the transceiving unit 102 acquires, from at least one base station, information of the change in the comparison, where the information may be the comparison itself or the changed overall wireless resource requirement, which is not limiting. In response to receiving of the information, the determining unit 101 and the executing unit 103 perform, for example, determination of the resource price and determination of the set of candidate base stations. The transceiving unit 102 then provides information of the resource prices to each base station.

In another example, each base station does not make determination, but reports updated information of the changed overall wireless resource requirement to the spectrum management device. The determining unit 101 determines, based on the update information reported by at least one base station, whether the change in the comparison reaches a predetermined degree. In a case of determining that the change reaches the predetermined degree, the determining unit 101 and the executing unit 103 perform the determination of the resource price and the determination of the set of candidate base stations. In this example, determination of the degree of the change in the comparison is performed by the spectrum management device.

As mentioned above, the determining unit 101 updates the resource price of at least one base station in response to the change in the comparison, the executing unit 103 re-determines the set of candidate base stations for each base station, and the transceiving unit 102 provides the updated resource prices to relevant base stations based on the re-determined set of candidate base stations. The UE re-determines, based on the updated resource prices, the base station to access. The determining unit 101, the executing unit 103 and the transceiving unit 102 perform the above operations iteratively, until a predetermined condition is satisfied.

The predetermined condition may include, for example, one or more of the following: the number of times of iterations reaches a predetermined value, and the maximum value of an update amount of the resource price between two iterations is less than a predetermined threshold. The update amount of the resource price of the base station decreases as the number of times of iterations increases. Therefore, termination of an iterative process may be controlled based on change of the update amount, and/or by directly controlling the number of times of iterations.

In an example, the iterations may be performed based on an Optimal Foraging Algorithm (OFA). OFA is a swarm intelligence algorithm proposed based on an ecological theory of animal behavior, the optimal foraging theory, in order to solve a global optimization problem of the animal foraging behavior. According to the optimal foraging algorithm, an optimal foraging position for an animal is solved by establishing a mathematical model through simulating animal foraging searching, prey identification time, food area and center position of foraging.

For example, the OFA may be implemented as follows. Initial foraging positions of individuals (i.e., foraging animals) are generated randomly in a constraint space, and then an objective function value (which is a net energy obtained by a foraging animal, the net energy being equal to the energy obtained by subtracting the energy consumed by the animal for foraging from the energy obtained from the foraging) of each of the individuals is calculated, and all the individuals are sorted according to objective function values thereof; an individual is randomly selected, from among all the individuals, as a reference sample; the objective function value of each of the individuals is compared with the reference sample, and if the objective function value of an individual is lower than that of the reference sample, the individual looks for a new foraging position in a direction to the reference sample; and if the objective function value of an individual is higher than that of the reference sample, the individual looks for a new foraging position in a direction opposite to the direction to the reference sample. In this way, an individual with a higher objective function value convenes an individual with a lower objective function value to move to a new foraging position, and each of the individuals tends to migrate from a foraging position where a low net energy can be obtained to a foraging position where a high net energy can be obtained.

It is determined whether the objective function value of the new foraging position is better than the previous position, that is, it is determined whether the objective function value of the individual in the new foraging position is higher than that in the previous position. If so, the new foraging position is reserved for the next foraging, otherwise the new foraging position is ignored and the previous foraging position is used for the next foraging.

The above steps are repeated, so as to search for the foraging position repeatedly using the optimized foraging algorithm, and the best position obtained in each time of foraging is recorded during the searching process. The recorded foraging position is determined as a final optimal solution when the algorithm terminates (for example, the number of iterations reaches a set value or change of the objective function value is less than a predetermined degree).

When applying the OFA to the embodiments, the foraging animals are equivalent to the UEs, the foraging positions are equivalent to the base stations, the objective function values are equivalent to the resource prices of the base stations, and a foraging animal looking for a foraging position with a higher objective function value in a region is equivalent to UE accessing a base station with a lower resource price within a region.

In addition, adaptations are made to OFA to suit for application scenarios of the present disclosure. For example, according to OFA, a foraging animal looks for an optimal position within a range of an entire region; while in the present disclosure, when searching for an accessible base station, UE needs to first determine whether the base station can be accessed, and select, among accessible base stations, the base station with a lower resource price. For example, the UE may determine whether a base station can be accessed by detecting strength of a pilot signal of the base station in a set of candidate base stations. On the other hand, according to the OFA algorithm, after the foraging position where a higher net energy can be obtained is found by a foraging animal, the foraging animal calls other animals to go to the foraging position. When applying the OFA algorithm to the present disclosure, the spectrum management device announces, through a base station, resource prices of base stations to a UE, and the UE selects to access the base station with a lower resource price.

It can be seen that, in the embodiment, the OFA algorithm is carried out collectively by the spectrum management device and the UE.

It should be understood that the OFA algorithm is only an example, and other swarm intelligence optimization algorithms may also be used to perform spectrum management based on resource prices.

When the iteration is terminated, it is considered that the UE is guided to access the base station with more idle resources, so that UEs are not concentrated, the total quantity of UE accesses in a given region is increased, and the spectrum utilization efficiency is improved.

In summary, the electronic apparatus 100 according to the embodiment determines a resource price by considering a comparison between a wireless resource supply capability of each of base stations and a wireless resource requirement of the UE for the base station, and performs spectrum management based on the resource price, so that the UE can dynamically select to access the base station with a lower resource price, a total quantity of UE accesses in a given region is increased, and the spectrum utilization efficiency is improved.

### Second Embodiment

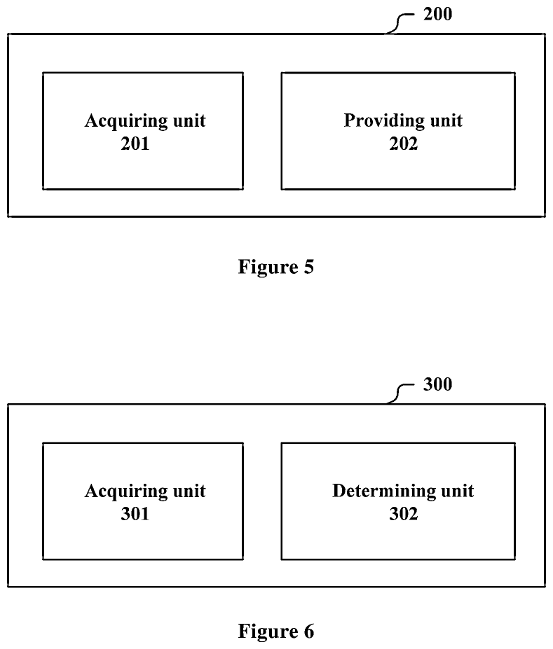

FIG. 5 is a block diagram showing functional modules of an electronic apparatus 200 for wireless communications according to another embodiment of the present disclosure. As shown in FIG. 5, the electronic apparatus 200 includes an acquiring unit 201 and a providing unit 202. The acquiring unit 201 is configured to acquire, from UE accessed in a base station, an overall wireless resource requirement of the UE. The providing unit 202 is configured to provide, to a spectrum management device, information of a comparison between the overall wireless resource requirement of the UE and wireless resources that the base station is capable of providing. The acquiring unit 201 is further configured to acquire, from the spectrum management device, a resource price of the base station determined by the spectrum management device based on the information and the resource prices of other base stations determined by the spectrum management device. The providing unit 202 is further configured to provide information of the resource prices to the UE accessed in the base station.

Similarly, the acquiring unit 201 and the providing unit 202 may be implemented by one or more processing circuits. The processing circuit may be implemented as a chip, for example. Moreover, it should be understood that functional units in the device shown in FIG. 5 are only logical modules divided based on specific functions thereof, and are not intended to limit a specific implementation.

The electronic apparatus 200 may, for example, be provided on a base station side of a resource application system or be communicatively connected to a base station (such as eNB or gNB). Here, it should be noted that the electronic apparatus 200 may be implemented at a chip level or a device level. For example, the electronic apparatus 200 may function as a base station itself, and may include external devices such as a memory and a transceiver (not shown). The memory may be configured to store programs required for performing various function by the base station and related data information. The transceiver may include one or more communication interfaces to support communications with different devices (such as user equipment, and other base stations). Implementation of the transceiver is not specifically limited herein.

Similar to the first embodiment, the wireless resource requirement may include one or more of the following: a spectrum requirement, a delay requirement, a reliability requirement, and a transmission rate requirement.

The acquiring unit 201 is configured to acquire a wireless resource requirement from each UE accessed in the base station to obtain an overall wireless resource requirement. The providing unit 202 is configured to provide, to a spectrum management device, information of a comparison between the overall wireless resource requirement and wireless resources that the base station is capable of providing, for the spectrum management device to determine a resource price based on the information. For example, the providing unit 202 may provide, to the spectrum management device, one or more of the following: the overall wireless resource requirement of the UE, resource supply information of wireless resources that the base station is capable of providing, location information of the base station, and transmission power information of the base station. Specific description about determination of the resource price is given in the first embodiment, and is not repeated here.

Here, the UE accessed in the base station may further include UE requesting to access the base station. In other words, the overall wireless resource requirement includes the wireless resource requirement of the UE requesting to access the base station.

Furthermore, the acquiring unit 201 acquires, from the spectrum management device, information of the resource price, where the resource price includes, for example, information including the resource price of the base station itself and resource prices of other base stations. The providing unit 202 provides the information to the UE, for the UE to re-select the base station to access based on at least the information. For example, the providing unit 202 may provide, to the UE, the information of the resource prices in a broadcasting manner; the UE that is requesting to access a base station may request, based on the information of the resource prices, to access another base station; and the UE already accessed in a base station may disconnect from the current base station and access another base station.

For example, a base station may be a base station in a set of candidate base stations, and UE accessed in the current base station may access the base stations in the set of candidate base stations. For example, the base station in the set of candidate base stations has a coverage range overlapping with the coverage range of the current base station, and has idle spectrum resources. In other words, the UE may select, based on at least the information of the resource prices, to access a base station in the set of candidate base statins whose resource price is lower than the resource price of the current base station. If the resource price of the current base station is the lowest price, the UE continues to access the current base station.

It may be understood that when the UE accesses to some other base station (referred to as a new base station) with a lower resource price, the overall wireless resource requirement of the original base station and the overall wireless resource requirement of the new base station change, that is, the comparison between overall wireless resource requirement and the wireless resource supply changes for each of the original base station and the new base station. The providing unit 202 is configured to, when a new UE requests to access the base station or accesses the base station, or when an accessed UE disconnects from the base station, determine change in the comparison, and provide information of the updated comparison to the spectrum management device.

In an example, the providing unit 202 is configured to provide information of the updated comparison to the spectrum management device when the comparison changes. For example, the providing unit 202 may provide information of an updated value of the comparison, or information of the updated overall wireless resource requirement of the UE. In this example, whether to update the resource price of the base station is determined by the spectrum management device based on the information of the updated comparison.

In another example, the providing unit 202 is configured to provide information of the updated comparison to the spectrum management device when the comparison changes to a predetermined degree. Similarly, the providing unit 202 may provide information of an updated value of the comparison, or information of the updated overall wireless resource requirement of the UE. In this example, the base station determines a degree of change in the comparison and determines whether it is necessary to report the change to the spectrum management device. When the information of the updated comparison is provided by the providing unit 202 to the spectrum management device, the spectrum management device updates the resource price of the base station.

In a case where the resource price of the base station changes, an access status of the UE may be affected and changes. For example, the UE currently accessed in the base station or the UE requesting to access the base station may choose to access another base station, or another UE may choose to access the base station. Further, the resource price of the base station may be updated again, forming a process of iteration. As described in the first embodiment, the iteration may terminate after a predetermined number of executions, or may terminate when a maximum value of updating amount of the resource price among the base stations is smaller than a predetermined threshold.

In summary, the electronic apparatus 200 according to the embodiment considers the resource price determined based on the comparison between the wireless resource supply capability of the base station and the wireless resource requirement of the UE for the base station, and assists in performing spectrum management based on the resource price, enabling the UE to dynamically choose to access the base station with a low resource price, so that the total quantity of UE accesses in a given region is increased, and the spectrum utilization efficiency is improved.

### Third Embodiment

FIG. 6 is a block diagram showing functional modules of an electronic apparatus 300 for wireless communications according to another embodiment of the present disclosure. As shown in FIG. 6, the electronic apparatus 300 includes an acquiring unit 301 and a determining unit 302. The acquiring unit 301 is configured to acquire, from a first base station that UE is currently requesting to access or accesses, information of a resource price of the first base station and the resource price of each of base stations in a set of candidate base stations, where the UE is capable of accessing each of the base station in the set of candidate base stations, the resource price is determined based on information of a comparison between an overall wireless resource requirement of the UE of the base station and wireless resources that the base station can provide. The determining unit 302 is configured to determine, based on at least the resource price, a second base station to access from among the set of candidate base stations, where the resource price of the second base station is lower than the resource price of the first base station.

The acquiring unit 301 and the executing unit 302 may be implemented by at least one processing circuit. The processing circuit may be implemented as a chip or a processor, for example. Moreover, it should be understood that functional units in the electronic apparatus shown in FIG. 6 are only logical modules divided according to specific functions implemented by the functional units, and are not intended to limit a specific implementation.

The electronic apparatus 300 may be provided on a UE side or communicatively connected to the UE, for example. Here, it should be noted that the electronic apparatus 300 may be implemented at a chip level or a device level. For example, the electronic apparatus 300 may function as the UE itself, and may include external devices such as a memory, and a transceiver (not shown). The memory may be configured to store programs required for performing various functions by the user equipment and related data information. The transceiver may include one or more communication interfaces to support communication with different devices (such as a base station, and other user equipment). Implementation of the transceiver is not particularly limited here.

It should be noted that terms such as first and second in this application are only for a purpose of distinction, and do not represent any sequence thereof.

Similarly, the wireless resource requirement may include one or more of the following: a spectrum requirement, a delay requirement, a reliability requirement, a transmission rate requirement, and the like.

Initially, the UE accesses the base station with a stronger pilot signal by, for example, comparing strengths of pilot signals received from respective base stations. The base station which the UE is currently accessed in is hereinafter referred to as a first base station.

Although not shown in FIG. 6, the electronic apparatus 300 may further include a providing unit configured to provide the wireless resource requirement of the UE to the first base station, for the first base station to count the overall wireless resource requirement of the UE for the first base station.

The first base station acquires, from the spectrum management device, information of the resource price of the base stations, and the acquiring unit 301 acquires the information from the first base station. For example, the acquiring unit 301 may obtain the information of the resource prices through broadcasting.

The information includes, for example, information of the resource price of the first base station and the resource price of each of base stations in the set of candidate base stations. The resource price of the base station is determined by the spectrum management device based on the comparison between the overall wireless resource requirement of the UE for the base station and a wireless resource supply of the base station. For example, the resource price may be in a positive correlation with the comparison.

In an example, the determining unit 302 determines, based on the received resource prices, a part of the base stations from among the set of candidate base stations each of which has a lower resource price than the resource price of the first base station, and randomly determines one of the part of the base stations as a second base station. If the resource price of the first base station is the lowest, the UE continues accessing the first base station. Here, as described above, the method through which the UE selects the second base station may be a part of the optimized foraging algorithm, that is, the determining unit 302 determines the second base station based on the optimized foraging algorithm.

In another example, the determining unit 302 is further configured to determine the second base station based on strength of pilot signals of the base stations. For example, the determining unit 302 determines a set of accessible base stations based on the strength of the received pilot signals of the base stations through detection of the UE, and randomly determines a second base station from among the set for accessing, where the resource price of the second base station is lower than the resource price of the first base station. Similarly, if the resource price of the first base station is the lowest, the UE continues to access the first base station.

In summary, the electronic apparatus 300 according to the embodiment selects a base station to access based on the resource price of each of the base stations determined based on a comparison between the wireless resource supply capability of the base station and the wireless resource requirement of the UE for the base station. In this way, the UE can dynamically select to access the base station with a lower resource price, so that a total quantity of UE accesses in a given region is increased, and the spectrum utilization efficiency is improved.

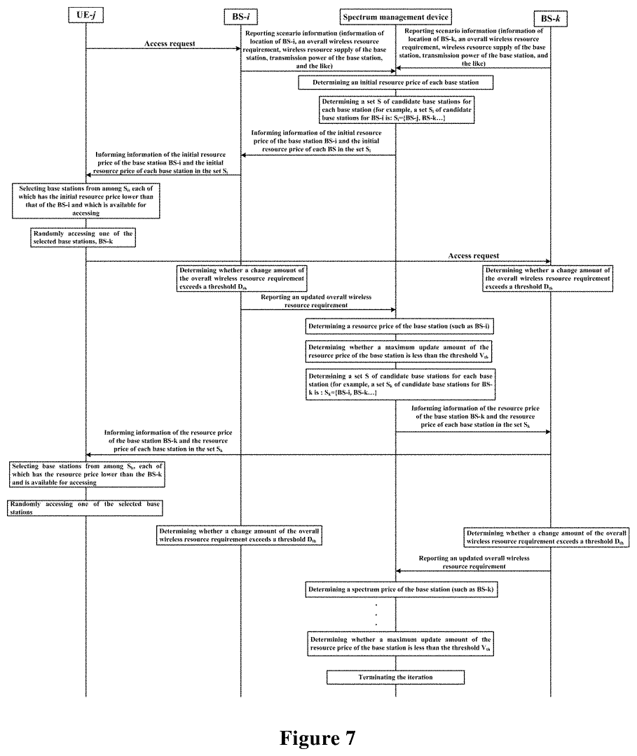

For ease of understanding, FIG. 7 shows a schematic diagram of an information procedure among the spectrum management device, the base station and the UE. In the example as FIG. 7, a spectrum management device, two exemplary base stations BS-i and BS-k and an exemplary UE UE-j are illustrated. It should be understood that this is exemplary only. First, UE-j determines, by detecting a pilot signal, to access the base station BS-i and transmits an access request to BS-i. The base station BS-i reports, to the spectrum management device, relevant scenario information such as a base station location, transmission power, an overall wireless resource requirement of the UE, and a wireless resource supply of the base station. The overall wireless resource requirement of the UE is obtained by counting the wireless resource requirement of each UE that requests to access the base station and UE that accesses the base station. Similarly, another base station, BS-k, reports relevant scenario information to the spectrum management device as well. The spectrum management device determines an initial resource price of each base station based on the received scenario information, and determines a set S of candidate base stations for each base station. For example, the set of candidate base stations for BS-i is denoted as Si. It should be noted that the base station itself may also be included in the set of candidate base stations for the base station, which is not limiting.

Next, the spectrum management device notifies the base station BS-i of information such as the initial resource price of the base station BS-i and the initial resource price of each base station in the set Si of candidate base stations. The base station BS-i notifies UE-j of the information. Similar operations are performed for the base station UE-k, which are not repeated here. The UE-j selects, from among Si, one or more base stations each having the initial resource price lower than that of the BS-i and available for accessing, and accesses one of the selected base stations randomly, such as BS-k. It should be understood that UE-j continues to access BS-i if the resource price of BS-i is lower than the resource price of any base station in Si.

UE-j transmits an access request to BS-k. Due to change of the access request status of UE-j and possible change of access state of other UE, the overall wireless resource requirement of the UE for BS-i and the overall wireless resource requirement of the UE for BS-k may change. In a case where the change exceeds a threshold Dₜₕ, the corresponding base station reports the updated overall wireless resource requirement to the spectrum management device. As shown in FIG. 7, the base station BS-i reports the updated overall wireless resource requirement to the spectrum management device as a variation of the overall wireless resource requirement for the base station BS-i exceeds Dₜₕ; and the base station BS-k does not perform reporting as the variation of the overall wireless resource requirement for the base station BS-k does not exceed Dₜₕ.

The spectrum management device re-determines the resource price of the base station such as the base station BS-i, and determines whether a maximum update amount of the resource price of each base station is less than a threshold Vₜₕ. The iteration is terminated if the maximum update amount of the resource price is less than the threshold Vₜₕ, or otherwise, if the maximum update amount of the resource price is greater than or equal to the threshold Vₜₕ, the spectrum management device determines the set of candidate base stations for the base station, and provide the base station with information about the resource prices of the base stations. In the example of FIG. 7, the maximum update amount of the resource price of each base station is not less than the threshold Vₜₕ, and the spectrum management device notifies the base station BS-k of information such as the resource price of the base station BS-k and the resource price of each base station in the set Sₖ of candidate base stations. The spectrum management device may notify the base station BS-i in a similar way. The base station BS-k notifies UE-j of the information. The UE-j selects, from among Sₖ, one or more base stations whose resource price is lower than that of BS-k and available for accessing, and accesses one of the selected base stations randomly. In the example of FIG. 7, the resource price of base station BS-k is lower than the resource price of any base station in Sₖ, and therefore UE-j does not access another base station, but continues to access base station BS-k.

Next, each of the base stations repeatedly performs determination of whether the variation of the overall wireless resource requirement exceeds the threshold Dₜₕ and reporting of the updated overall wireless resource requirement. The spectrum management device repeatedly performs updating of the resource price and determination of whether the update amount of the resource price being less than the threshold Vₜₕ.

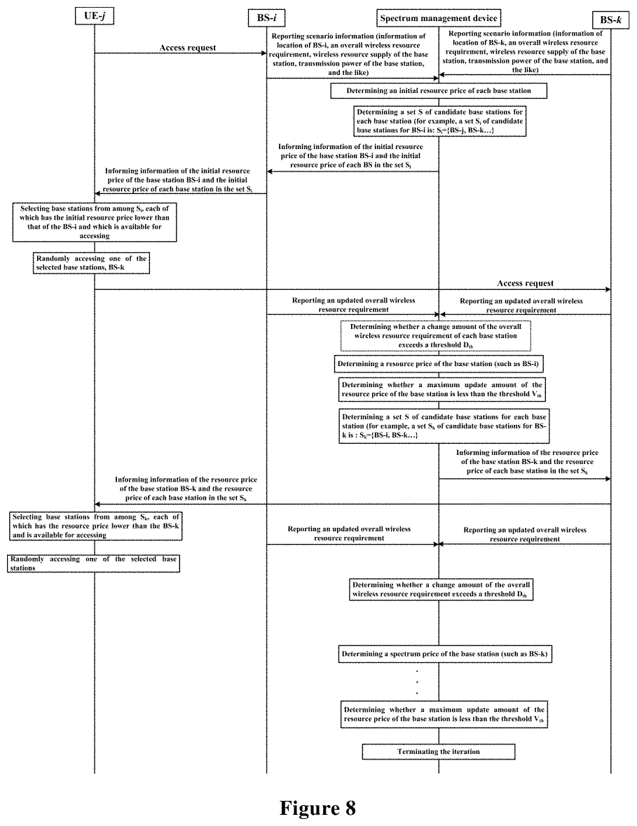

FIG. 8 shows a schematic diagram of another information procedure among the spectrum management device, the base station and the UE. A difference between FIG. 8 and FIG. 7 is that the base station does not perform determination of whether a variation of the overall wireless resource requirement exceeding Dₜₕ, but directly reports the updated overall wireless resource requirement for the spectrum management device to perform the determination. The other parts are exactly the same as those in FIG. 7 and are not repeated here.

Further, a simulation example is provided to illustrate advantages of the resource price-based dynamic spectrum management according to the present disclosure.

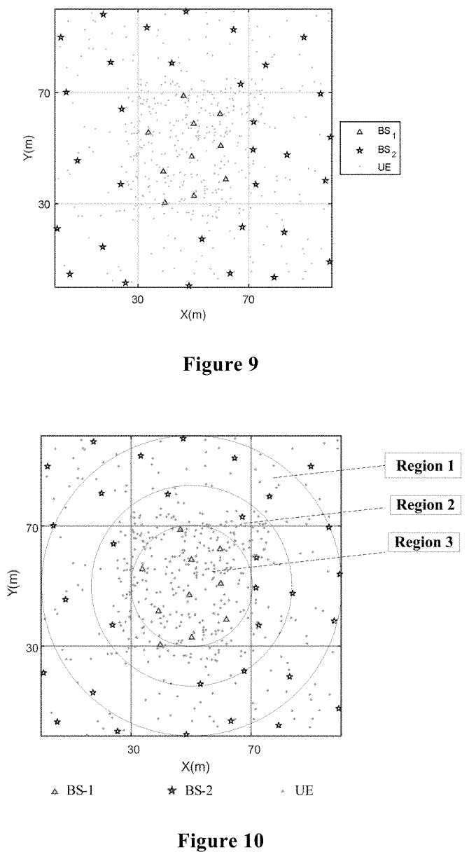

FIG. 9 shows a schematic diagram of a simulation scenario, which takes a densely populated central commercial street as an example, and a distribution of base stations obeys the Hard-Core Poisson Point Process. Two types of base stations are used in the simulation scenario. The triangles in the figure represent a first type of base stations, and the stars represent a second type of base stations. A distance between any two base stations in the first type is not less than 5 m, and each of the base stations has a coverage radius of 10 m. The distance between any two base stations in the second type is not less than 7.5 m, and each of the base stations has a coverage radius of 20 m. UEs are represented by dots, which are in a random uniform distribution but with different distribution densities. 60% of the UEs are randomly distributed within a central ¼ region (X: 25 m to 75 m, Y: 25 m to 75 m), and the remaining 40% of the UEs are randomly distributed in surrounding areas. Specific parameters of the system are configured as follows: simulation region is 100 m×100 m; the number of base stations is 140; the number of UEs is 1400; the number of channels of a base station is 10; center frequency of a base station is 2 GHz; a bandwidth is 10 MHz.

In the simulation, the solution provided in the present disclosure is compared with a conventional solution in which a UE accesses in a neighboring base station. According to the conventional solution, UEs are distributed in the space unevenly, some of the UEs are unable to access a base station since a resource supply of some base station is less than the resource requirement of these UEs for the base station; meanwhile, the resource supply of one or more of the base stations is greater than the resource requirement of a UE for the base stations, resulting in a waste of spectrum of the base stations. In the present disclosure, the resource price is determined dynamically based on the resource supply of a base station and the resource requirement of a UE, and the UE accesses, based on the optimized foraging algorithm, the base station with a lower resource price, so that spectrum of the base station for which the resource requirement is greater than the resource supply is available for the UE that cannot access the base station under the conventional solution, thereby increasing a total quantity of UEs accessing the base stations.

It is supposed that the simulated scenario is divided into three parts, i.e., region 1, region 2, and region 3, as shown in FIG. 10. It is assumed that the resource requirement of UEs for a base station in region 1 is less than the resource supply of the base station, and the resource price of the base station in region 1 is set to p₁; the resource requirement of UEs for a base station in region 2 is roughly equal to the resource supply of the base station, and the resource price of the base station in region 2 is set to p₂; and the resource requirement of UEs for a base station in region 3 is greater than the resource supply of the base station, and the resource price of the base station in region 3 is set to p₃. According to equation (1), it may be obtained that p₁<p₂<p₃.

Since the resource price in region 1 is lower than the resource price in region 2 (p₁<p₂), a part of UEs in region 2 access one or more base stations in region 1. In this case, the resource requirement of UEs in region 2 for base stations in region 2 decreases, and the resource price of the base station decreases. The resource price in region 3 is higher than the resource price in region 2 (p₂<p₃), and therefore some of UEs in region 3 access one or more base stations in region 2, and the base stations in region 3 may have some idle resources. The idle resources in region 3 are provided for UEs that cannot access the base station due to lack of available spectrum resources.

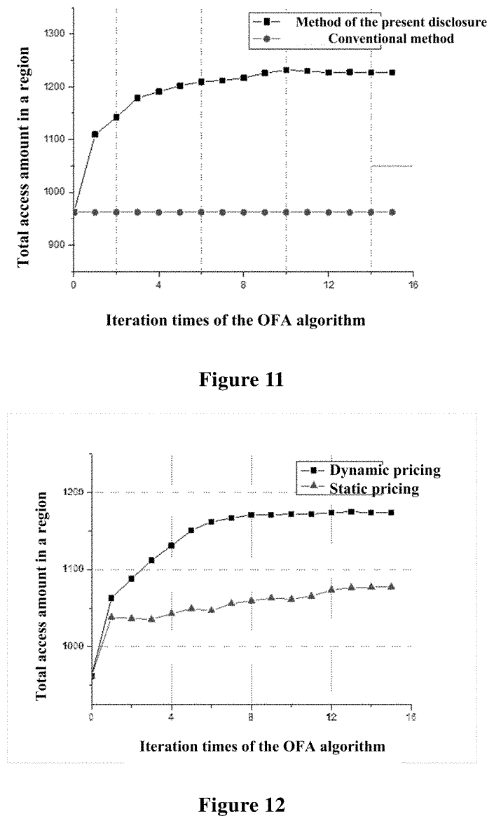

FIG. 11 is a graph showing a comparison between the solution of the present disclosure and a conventional solution in terms of total access amount of user equipment. As shown in FIG. 11, the resource price-based dynamic spectrum management method in the present disclosure lead to a nearly 30% increase of the total access of UE.

The above solution in the present disclosure is called a dynamic pricing scheme. In addition, a static pricing may be used, that is, after the UE accesses a base station for a first time, the spectrum management device determines the resource price based on the resource supply of the base station and the total resource requirement of the UE, and then the resource price remains unchanged. FIG. 12 is a graph showing performance of a dynamic pricing scheme versus a static pricing scheme. FIG. 12 shows a comparison of total numbers of connected UE, that is, a comparison of total amount of UE access. It can be seen that the dynamic pricing scheme is more effective in improving the total access amount of UE than the static pricing scheme.

Furthermore, as mentioned above, the resource price may be determined as a step-like function with respect to the ratio of the overall wireless resource requirement to the wireless resource supply, that is, a tiered pricing is adopted. The effect of the number of tiers of the tiered pricing on the total access amount of UE is shown through a simulation below.

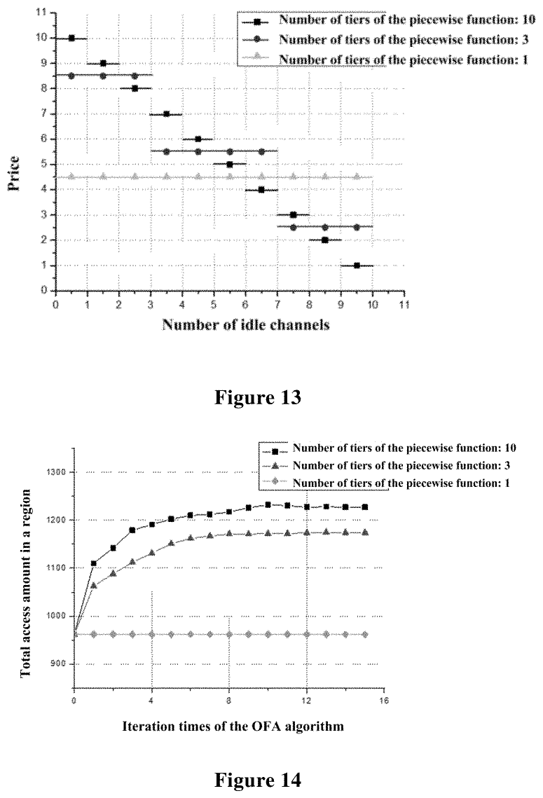

In the simulation, each of base stations has 10 channels to be allocated to the UE, and a resource price of the base station may be determined based on the number of idle channels of the base station. For example, a 3-tier pricing scheme means that three kinds of the resource prices of the base stations are determined based on the number of idle channels of the base stations: the resource price of a base station is p_{1,1} if the base station has 1 to 3 idle channels; the resource price of a base station is p_{1,2} if the base station has 4 to 7 idle channels; and the resource price of a base station is p_{1,3} if the base station has 8 to 10 idle channels. Similarly, a 10-tier pricing scheme means that 10 kinds of the resource prices of the base stations are determined based on the number of idle channels of the base station: the resource price of a base station is p_{2,1} if the base station has 1 idle channel; the resource price of a base station is p_{2,2} if the base station has 2 idle channels; the resource price of a base station is p_{2,3} if the base station has 3 idle channels; and so on. In the conventional solution, the number of idle channels of the base station is not considered, that is, the resource price of the base stations equal to a uniform value, for example, p₃. FIG. 13 shows a schematic diagram of an example of the tiered pricing.

FIG. 14 is a graph showing effects of different tiers of tiered pricing on a total access amount of user equipment. It can be seen that in a case where the number of tiers of the tiered pricing is less than the total number of channels that may be allocated by the base station, more tiers of the tiered pricing leads to a greater total access of UEs in the region; in a case where the number of tiers of the tiered pricing is equal to the number of channels that can be allocated by the base station, the total access amount of UE reaches the maximum; and in a case where the number of tiers of the tiered pricing is greater than the total number of channels of the base station, the total access amount of the UE does not change with the increase of the number of tiers of the tiered pricing.

It should be noted that the above simulation is provided for ease of understanding, and is not intended to limit the present disclosure.

### Fourth Embodiment

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

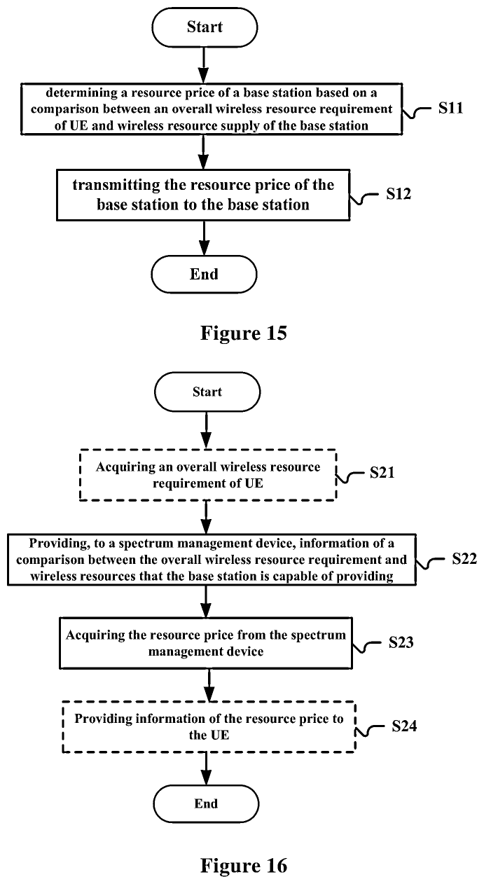

FIG. 15 shows a flowchart of a method for wireless communication according to an embodiment of the present disclosure. The method includes: determining (S11), based on a comparison between an overall wireless resource requirement of UE accessing a base station within a predetermined region and wireless resources that the base station is capable of providing, a resource price of the base station; and transmitting (S12), to the base station, the resource price of the base station, so that the UE determines whether to access the base station based on at least the resource price. The method may be performed, for example, on a spectrum management device side.

In step S11, the resource price of the base station may be determined based on the ratio of the overall wireless resource requirement of the UE to a wireless resource supply of the base station, and the resource price is determined to be positively correlated with the ratio. For example, the resource prices can be determined as a step-like function of the ratio.

In addition, the above method may further include a step of acquiring, from the base station, one or more of the following information: information of the overall wireless resource requirement of the UE accessed in the base station; resource supply information of the wireless resources that the base station can provide; location information of the base station; and information of transmission power of the base station.

The above method may further include a step of providing each base station with information of the resource price. For example, for each base station, a set of candidate base stations may be determined for the base station, and the resource price of the base station and the resource price of each base station in the set of candidate base stations may be provided to the base station, where the UE accessed in the base station can access the base stations in the set of candidate base stations. For example, a base station of which the coverage range overlaps with the coverage range of the base station and which has a wireless resource supply capability may be determined as a base station in the set of candidate base stations.

The above method further include a step of performing spectrum management dynamically in response to a change in the comparison with respect to at least one base station in a case where the change reaches a predetermined degree.

For example, the resource price of at least one base station may be updated in response to a change in the comparison and the set of candidate base stations may be re-determined, and the updated resource price may be provided to a relevant base station based on the re-determined set of candidate base stations. The UE re-determines, based on the updated resource price, the base station to access. The resource price and the set of candidate base stations are updated and provided in an iterative manner until a predetermined condition is satisfied. For example, the predetermined conditions include one or more of the following: a number of times of iteration reaches a predetermined value, and the maximum value of an update amount of the resource price between two iterations is less than a predetermined threshold. The iteration may be performed, for example, based on an optimized foraging algorithm.

In an example, the information of change in the comparison may be obtained from at least one base station. In another example, it may be determined, based on update information reported by at least one base station, whether the change in the comparison reaches a predetermined degree, where the update information includes updated information of the overall wireless resource requirement.

For example, the wireless resource requirement may include one or more of the following: a spectrum requirement, a delay requirement, a reliability requirement, and a transmission rate requirement.

FIG. 16 shows a flowchart of a method for wireless communications according to another embodiment of the present disclosure. The method includes: acquiring (S21), from UE accessed in a base station, an overall wireless resource requirement of the UE; providing (S22), to a spectrum management device, information of a comparison between the overall wireless resource requirement of the UE and wireless resources that the base station is capable of providing; acquiring (S23), from the spectrum management device, a resource price of the base station determined by the spectrum management device based on the information and the resource price of another base station determined by the spectrum management device; and providing (S24) information of the resource price to the UE accessed in the base station. The method may be performed at a base station side, for example.

For example, the another base station is a base station in the set of candidate base stations, where the UE accessed in the base station may access the base station in the set of candidate base stations.

In step S24, the information of the resource price may be provided to the user equipment in a broadcasting manner.

The method further includes: determining a change in the comparison when new user equipment requests to access the base station or accesses the base station, or when the user equipment accessed in the base station disconnects from the base station, and providing updated information of the comparison to the spectrum management device.

For example, information of the updated overall wireless resource requirement of the UE may be provided to the spectrum management device.

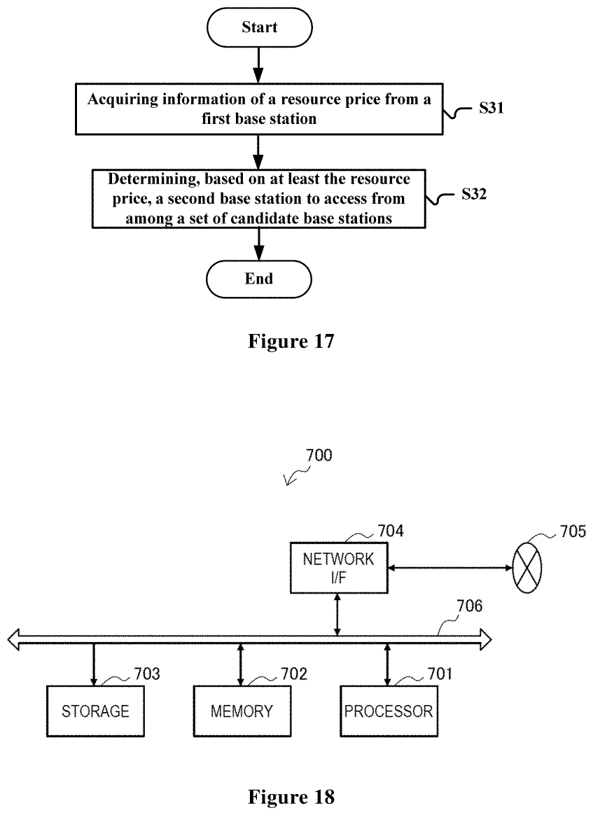

FIG. 17 shows a flowchart of a method for wireless communications according to another embodiment of the present disclosure. The method includes: acquiring (S31), from a first base station which UE is currently requesting to access or accesses, information of a resource price of the first base station and the resource price of each base station within a set of candidate base stations, where the UE is capable of accessing the base station within the set of candidate base stations, and the resource price is determined based on information of a comparison between an overall wireless resource requirement of the UE for a base station and wireless resources that the base station is capable of providing; and determining (S32), based on at least the resource price, a second base station to access from among the set of candidate base stations, where the resource price of the second base station is lower than the resource price of the first base station.

For example, in step S31, information of the resource price may be acquired in a broadcasting manner.

In step S32, a part of base stations whose resource price is lower than the resource price of the first base station may be determined from among the set of candidate base stations, and one of the part of the base stations may be determined as the second base station randomly. For example, the second base station may be determined based on an optimized foraging algorithm. In addition, in step S32, the second base station may be determined based on strength of a pilot signal of each base station. In addition, in a case that the resource price of the first base station is the lowest, it is determined to continue to access the first base station.

It should be noted that the methods may be used in combination or individually, and details thereof are described in detail in the first to third embodiments, and are not repeated here.

The technology in the present disclosure may be applied to various products.

The electronic apparatus 100 may be implemented as any type of server, such as a tower server, a rack server, and a blade server. The electronic apparatus 100 may be a control module mounted on a server (such as an integrated circuitry module including a single die, and a card or blade inserted into a slot of a blade server).

For example, the electronic apparatus 200 may be implemented as various base stations. The base station may be implemented as any type of evolved node B (eNB) or gNB (a 5G base station). The eNB includes, for example, a macro eNB and a small eNB. The small eNB may be an eNB covering a cell smaller than a macro cell, such as a pico eNB, a micro eNB, and a home (femto) eNB. The case for the gNB is similar to the above. Alternatively, the base station may be implemented as any other type of base station, such as a NodeB and a base transceiver station (BTS). The base station may include: a main body (also referred to as a base station apparatus) configured to control wireless communication; and one or more remote radio head ends (RRH) located at positions different from the main body. In addition, various types of user equipment may each serve as a base station by performing functions of the base station temporarily or semi-permanently.

For example, the electronic apparatus 300 may be implemented as various user equipments. The user equipment may be implemented as a mobile terminal (such as a smartphone, a tablet personal computer (PC), a notebook PC, a portable game terminal, a portable/dongle-type mobile router, and a digital camera device) or an in-vehicle terminal such as a car navigation apparatus. The user equipment may also be implemented as a terminal (also referred to as a machine type communication (MTC) terminal) that performs machine-to-machine (M2M) communication. In addition, the user equipment may be a wireless communication module (such as an integrated circuit module including a single chip) mounted on each of the terminals described above.

### Application Example Regarding a Server

FIG. 18 is a block diagram of an example of an exemplary configuration of a server 700 to which the technology according to the present disclosure may be applied. The server 700 includes a processor 701, a memory 702, a storage 703, a network interface 704, and a bus 706.

The processor 701 may be, for example, a central processing unit (CPU) or a digital signal processor (DSP), and controls functions of the server 700. The memory 702 includes a random access memory (RAM) and a read-only memory (ROM), and stores data and a program executed by the processor 701. The storage 703 may include a storage medium, such as a semiconductor memory and a hard disk.

The network interface 704 is a wired communication interface for connecting the server 700 to a wired communication network 705. The wired communication network 705 may be a core network such as an Evolved Packet Core (EPC), or a packet data network (PDN) such as the Internet.

The bus 706 connects the processor 701, the memory 702, the storage 703, and the network interface 704 to each other. The bus 706 may include two or more buses having different speeds (such as a high-speed bus and a low-speed bus).

In the server 700 shown in FIG. 18, the determining unit 101, the transceiving unit 102, the executing unit 103, and the like, described with reference to FIG. 1 and FIG. 2 may be implemented by the processor 701. For example, the processor 701 may perform functions of the determining unit 101, the transceiving unit 102, and the executing unit 103 to determine a resource price of each base station and perform spectrum management based on the resource price.

### Application Examples Regarding a Base Station

### First Application Example

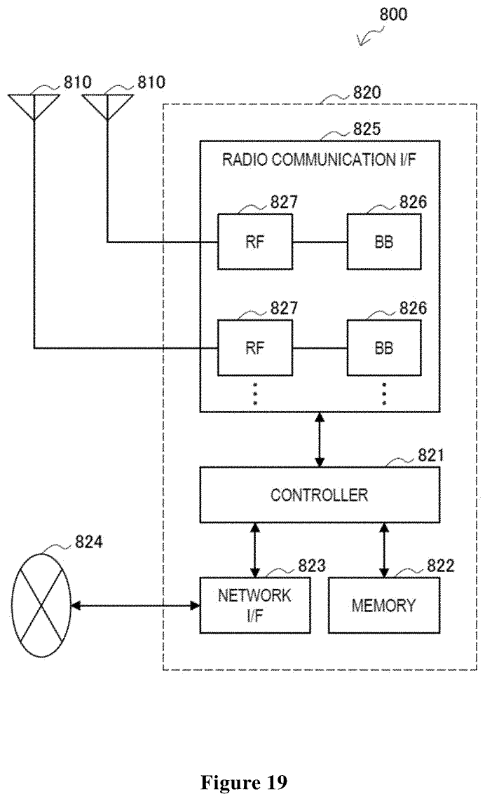

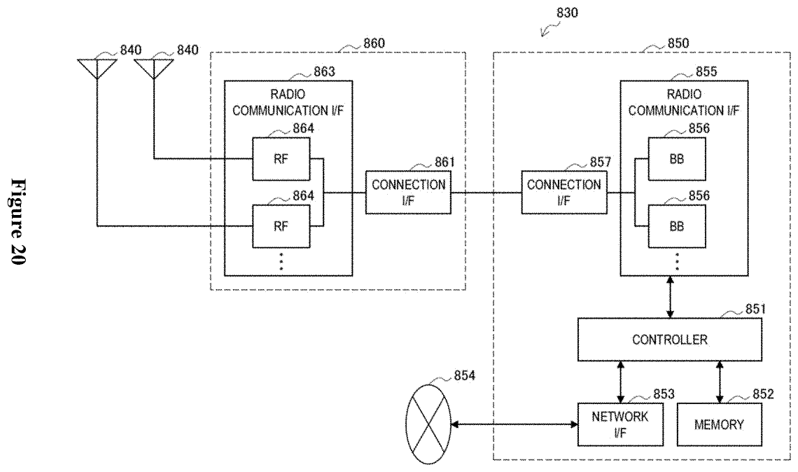

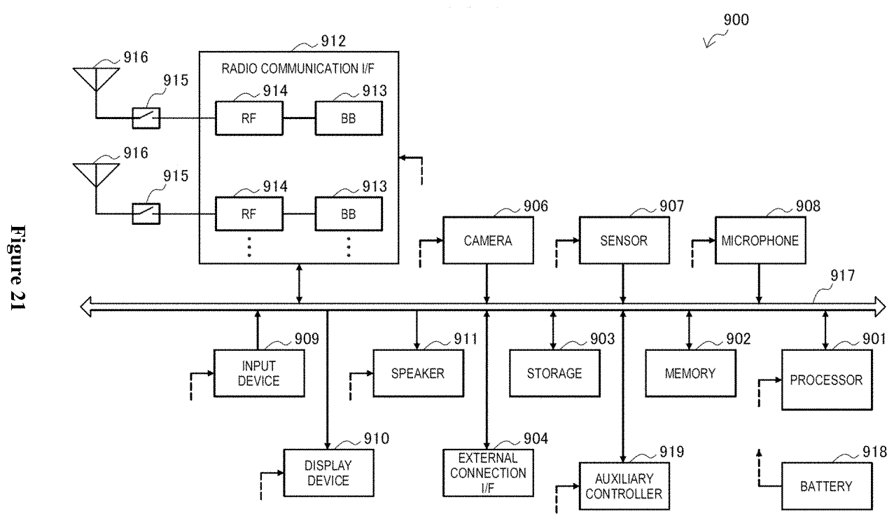

FIG. 19 is a block diagram showing a first example of an exemplary configuration of an eNB or gNB to which the technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via a radio frequency (RF) cable.

Each of the antennas 810 includes a single or multiple antennal elements (such as multiple antenna elements included in a multiple-input multiple-output (MIMO) antenna), and is used for the base station apparatus 820 to transmit and receive wireless signals. As shown in FIG. 19, the eNB 800 may include the multiple antennas 810. For example, the multiple antennas 810 may be compatible with multiple frequency bands used by the eNB 800. Although FIG. 19 shows the example in which the eNB 800 includes the multiple antennas 810, the eNB 800 may include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate bundled packet, and transfer the generated bundled packet. The controller 821 may have logical functions of performing control such as wireless resource control, wireless bearer control, mobility management, admission control and scheduling. The control may be performed in corporation with an eNB or a core network node in the vicinity. The memory 822 includes a RAM and a ROM, and stores a program executed by the controller 821 and various types of control data (such as a terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an S1 interface and an X2 interface). The network interface 823 may also be a wired communication interface or a wireless communication interface for wireless backhaul. If the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and perform various types of signal processing of layers (such as L1, Media Access Control (MAC), Radio Link Control (RLC), and a Packet Data Convergence Protocol (PDCP)). The BB processor 826 may have a part or all of the above-described logical functions instead of the controller 821. The BB processor 826 may be a memory storing communication control programs, or a module including a processor and a related circuit configured to execute the programs. Updating the program may allow the functions of the BB processor 826 to be changed. The module may be a card or a blade inserted into a slot of the base station apparatus 820. Alternatively, the module may be a chip mounted on the card or the blade. Meanwhile, the RF circuit 827 may include, for example, a mixer, a filter, and an amplifier, and transmits and receives wireless signals via the antenna 810.

As shown in FIG. 19, the radio communication interface 825 may include multiple BB processors 826. For example, the multiple BB processors 826 may be compatible with multiple frequency bands used by the eNB 800. The radio communication interface 825 may include multiple RF circuits 827, as shown in FIG. 19. For example, the multiple RF circuits 827 may be compatible with multiple antenna elements. Although FIG. 19 shows the example in which the radio communication interface 825 includes multiple BB processors 826 and multiple RF circuits 827, the radio communication interface 825 may include a single BB processor 826 and a single RF circuit 827.

In the eNB 800 shown in FIG. 19, the acquiring unit 201, the providing unit 202, and a transceiver of the electronic apparatus 200 may be implemented by the radio communication interface 825. At least a part of the functions may also be implemented by the controller 821. For example, the controller 821 may perform the functions of the acquiring unit 201 and the providing unit 202 to obtain information of the resource price of the base station and provide, to the spectrum management device, information of a comparison between the overall wireless resource requirement of the UE and the wireless resource supply of the base station.

### Second Application Example

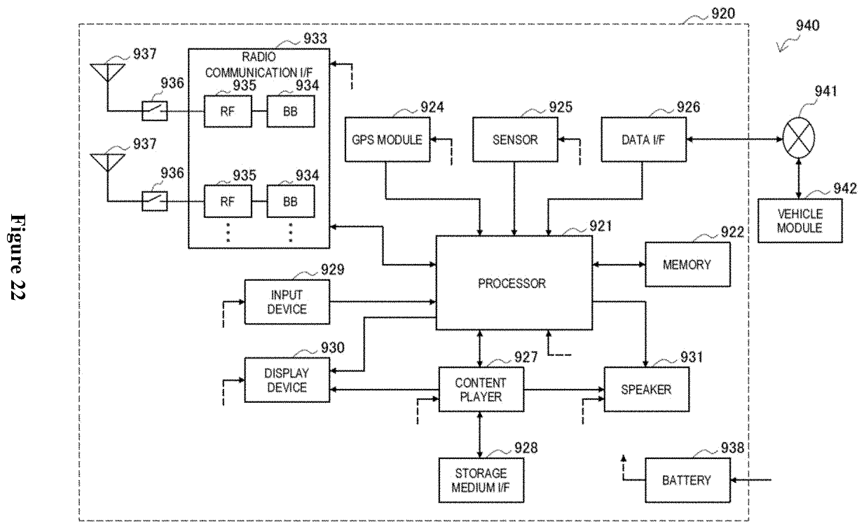

FIG. 20 is a block diagram showing a second example of an exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As shown in FIG. 20, the eNB 830 may include multiple antennas 840. For example, the multiple antennas 840 may be compatible with multiple frequency bands used by the eNB 830. Although FIG. 20 shows the example in which the eNB 830 includes multiple antennas 840, the eNB 830 may include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 19.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 19, except that the BB processor 856 is connected to an RF circuit 864 of the RRH 860 via the connection interface 857. As show in FIG. 20, the radio communication interface 855 may include multiple BB processors 856. For example, the multiple BB processors 856 may be compatible with multiple frequency bands used by the eNB 830. Although FIG. 20 shows the example in which the radio communication interface 855 includes multiple BB processors 856, the radio communication interface 855 may include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, an RF circuit 864. The RF circuit 864 may include, for example, a mixer, a filter and an amplifier, and transmits and receives wireless signals via the antenna 840. The radio communication interface 863 may include multiple RF circuits 864, as shown in FIG. 20. For example, the multiple RF circuits 864 may support multiple antenna elements. Although FIG. 20 shows the example in which the radio communication interface 863 includes multiple RF circuits 864, the radio communication interface 863 may include a single RF circuit 864.

In the eNB 830 shown in FIG. 20, the acquiring unit 201, the providing unit 202 and a transceiver of the electronic apparatus 200 may be implemented by the radio communication interface 855 and/or the radio communication interface 866. At least a part of the functions may also be implemented by the controller 851. For example, the controller 851 may perform the functions of the acquiring unit 201 and the providing unit 202 to obtain information of the resource price of the base station and provide, to the spectrum management device, information of a comparison between the overall wireless resource requirement of the UE and the wireless resource supply of the base station.

### Application Examples Regarding User Equipment

### First Application Example

FIG. 21 is a block diagram showing an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals outputted from the smartphone 900 to sounds.

The radio communication interface 912 supports any cellular communication scheme (such as LTE and LTE-advanced), and performs wireless communication. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. It should be noted that although FIG. 21 shows a case that one RF link is connected to one antenna, which is only illustrative, and a situation where one RF link is connected to multiple antennas through multiple phase shifters is also possible. The radio communication interface 912 may be a chip module having the BB processor 913 and the RF circuit 914 integrated thereon. The radio communication interface 912 may include multiple BB processors 913 and multiple RF circuits 914, as shown in FIG. 21. Although FIG. 21 shows the example in which the radio communication interface 912 includes multiple BB processors 913 and multiple RF circuits 914, the radio communication interface 912 may include a single BB processor 913 or a single RF circuit 914.

Furthermore, in addition to a cellular communication scheme, the radio communication interface 912 may support another type of wireless communication scheme such as a short-distance wireless communication scheme, a near field communication scheme, and a wireless local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as shown in FIG. 21. Although FIG. 21 shows the example in which the smartphone 900 includes multiple antennas 916, the smartphone 900 may include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 shown in FIG. 21 via feeder lines, which are partially shown as dashed lines in FIG. 21. The auxiliary controller 919 operates a minimum necessary function of the smartphone 900, for example, in a sleep mode.

In the smart phone 900 shown in FIG. 21, the acquiring unit 301, a transceiver of the electronic apparatus 300 may be implemented by the radio communication interface 912. At least a part of the functions may be implemented by the processor 901 or the auxiliary controller 919. For example, the processor 901 or the auxiliary controller 919 may perform the functions of the acquiring unit 301 and the determining unit 202 to access, based on the resource price, a base station with a lower resource price.

### Second Application Example

FIG. 22 is a block diagram showing an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not shown, and acquires data (such as vehicle speed data) generated by the vehicle.

The content player 927 reproduces content stored in a storage medium (such as a CD and DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or reproduced content. The speaker 931 outputs a sound for the navigation function or the reproduced content.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as shown in FIG. 22. Although FIG. 22 shows the example in which the radio communication interface 933 includes multiple BB processors 934 and multiple RF circuits 935, the radio communication interface 933 may include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used for the radio communication interface 933 to transmit and receive wireless signals. As shown in FIG. 22, the car navigation apparatus 920 may include multiple antennas 937. Although FIG. 22 shows the example in which the car navigation apparatus 920 includes multiple antennas 937, the car navigation apparatus 920 may include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 shown in FIG. 22 via feeder lines that are partially shown as dash lines in FIG. 22. The battery 938 accumulates power supplied from the vehicle.

In the car navigation device 920 shown in FIG. 22, the acquiring unit 301 and a transceiver of the electronic apparatus 300 may be implemented by the radio communication interface 912. At least a part of the functions may be implemented by the processor 921. For example, the processor 921 may perform the functions of the acquiring unit 301 and the determining unit 302 to access, based on the resource price, a base station with a lower resource price.

The technology of the present disclosure may also be implemented as an in-vehicle system (or a vehicle) 940 including one or more blocks of the car navigation apparatus 920, the in-vehicle network 941 and a vehicle module 942. The vehicle module 942 generates vehicle data (such as a vehicle speed, an engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

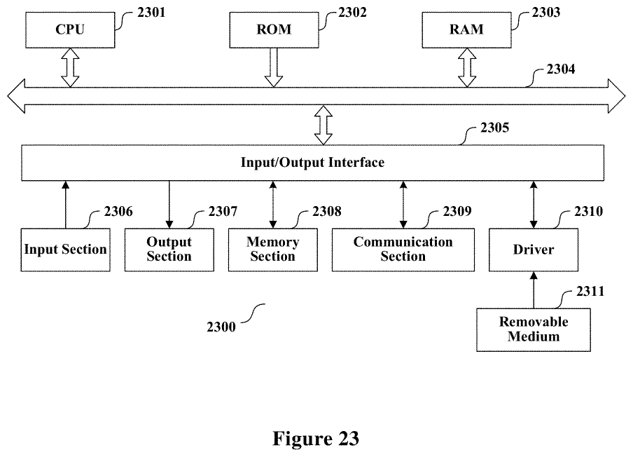

In the case where the present disclosure is realized with software or firmware, a program constituting the software is installed in a computer with a dedicated hardware structure (e.g. the general computer 2300 shown in FIG. 23) from a storage medium or network, wherein the computer is capable of implementing various functions when installed with various programs.

In FIG. 23, a central processing unit (CPU) 2301 executes various processing according to a program stored in a read-only memory (ROM) 2302 or a program loaded to a random access memory (RAM) 2303 from a memory section 2308. The data needed for the various processing of the CPU 2301 may be stored in the RAM 2303 as needed. The CPU 2301, the ROM 2302 and the RAM 2303 are linked with each other via a bus 2304. An input/output interface 2305 is also linked to the bus 2304.

The following components are linked to the input/output interface 2305: an input section 2306 (including keyboard, mouse and the like), an output section 2307 (including displays such as a cathode ray tube (CRT), a liquid crystal display (LCD), a loudspeaker and the like), a memory section 2308 (including hard disc and the like), and a communication section 2309 (including a network interface card such as a LAN card, modem and the like). The communication section 2309 performs communication processing via a network such as the Internet. A driver 2310 may also be linked to the input/output interface 2305, if needed. If needed, a removable medium 2311, for example, a magnetic disc, an optical disc, a magnetic optical disc, a semiconductor memory and the like, may be installed in the driver 2310, so that the computer program read therefrom is installed in the memory section 2308 as appropriate.

In the case where the foregoing series of processing is achieved through software, programs forming the software are installed from a network such as the Internet or a memory medium such as the removable medium 2311.

It should be appreciated by those skilled in the art that the memory medium is not limited to the removable medium 2311 shown in FIG. 23, which has program stored therein and is distributed separately from the apparatus so as to provide the programs to users. The removable medium 2311 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 2302 and the memory section 2308 in which programs are stored, and can be distributed to users along with the device in which they are incorporated.

To be further noted, in the apparatus, method and system according to the present disclosure, the respective components or steps can be decomposed and/or recombined. These decompositions and/or re-combinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
processing circuitry, configured to:
determine, based on a comparison between an overall wireless resource requirement of user equipment (UE) accessed in a base station within a predetermined region and wireless resources that the base station is capable of providing, a resource price of the base station; and
transmit, to the base station, the resource price of the base station, so that the UE determines whether to access the base station based on at least the resource price.

2. The electronic apparatus according to claim 1, wherein, the processing circuitry is configured to determine the resource price of the base station based on a ratio of the overall wireless resource requirement of the UE to a wireless resources supply of the base station, and the processing circuitry is configured to determine the resource price as being positively correlated to the ratio.

3. The electronic apparatus according to claim 2, wherein the processing circuitry is configured to determine the resource price as a step-like function of the ratio.

4. The electronic apparatus according to claim 1, wherein the processing circuitry is further configured to acquire, from the base station, one or more items of the following information: information of the overall wireless resource requirement of the UE accessed in the base station; resource supply information of wireless resources capable of being provided by the base station; location information of the base station; and information of transmission power of the base station.

5. The electronic apparatus according to claim 1, wherein the processing circuitry is further configured to determine, with respect to each base station, a set of candidate base stations for the base station, and provide the resource price of the base station and the resource price of each base station within the set of candidate base stations to the base station, wherein UE accessed in the base station is capable of accessing a base station within the set of candidate base stations.

6. The electronic apparatus according to claim 5, wherein the processing circuitry is further configured to determine a base station a coverage range of which overlaps with the coverage range of the base station and having a wireless resource supply capability as a base station in the set of candidate base stations.

7. The electronic apparatus according to claim 5, wherein the processing circuitry is further configured to perform spectrum management dynamically in response to a change in the comparison with respect to at least one base station, in a case that the change reaches a predetermined degree.

8. The electronic apparatus according to claim 7, wherein the processing circuitry is configured to: update the resource price of the at least one base station and re-determine the set of candidate base stations in response to the change in the comparison; and provide, based on the re-determined set of candidate base stations, the updated resource price to relevant base stations, wherein the user equipment re-determines the base station to access based on the updated resource price,
wherein the processing circuitry is configured to update and provide both the resource price and the set of candidate base stations in an iterative manner until a predetermined condition is satisfied.

9. The electronic apparatus according to claim 8, wherein the predetermined condition comprise one or more of the following: a number of iterations reaches a predetermined value, and a maximum value of an update amount of the resource price between two iterations is less than a predetermined threshold.

10. The electronic apparatus according to claim 7, wherein the processing circuitry is configured to acquire, from the at least one base station, information of change in the comparison.

11. The electronic apparatus according to claim 7, wherein the processing circuitry is configured to determine whether the change in the comparison reaches the predetermined degree based on updated information reported by the at least one base station, wherein the updated information comprises information of the updated overall wireless resource requirement.

12. The electronic apparatus according to claim 8, wherein the processing circuitry is configured to perform the iteration based on an optimized foraging algorithm.

13. The electronic apparatus according to claim 1, wherein the wireless resource requirement comprises one or more of the following: a spectrum requirement, a delay requirement, a reliability requirement, and a transmission rate requirement.

14. An electronic apparatus for wireless communications, comprising:
processing circuitry configured to:
acquire, from UE accessed in a base station, an overall wireless resource requirement of the UE;
provide, to a spectrum management device, information of a comparison between the overall wireless resource requirement of the UE and wireless resources that the base station is capable of providing;
acquire, from the spectrum management device, a resource price of the base station determined by the spectrum management device based on the information as well as the resource price of another base station determined by the spectrum management device; and
provide information of the resource price to the UE accessed in the base station.

15. The electronic apparatus according to claim 14, wherein the another base station is a base station in a set of candidate base stations, and wherein the user equipment accessed in the base station is capable of accessing the base station in the set of candidate base stations.

16. The electronic apparatus according to claim 14, wherein the processing circuitry is configured to provide the user equipment with information of the resource price in a broadcasting manner.

17. The electronic apparatus according to claim 14, wherein the processing circuitry is further configured to determine a change in the comparison when a new user equipment requests to access the base station or accesses the base station, or when the user equipment accessed in the base station disconnects from the base station, and provide information of an updated comparison to the spectrum management device.

18. The electronic apparatus according to claim 17, wherein the processing circuitry is further configured to provide the information of the updated comparison to the spectrum management device in a case that the change in the comparison reaches a predetermined degree.

19. The electronic apparatus according to claim 17, wherein the processing circuitry is configured to provide the spectrum management device with information of an updated overall wireless resource requirement of the user equipment.

20. The electronic apparatus according to claim 14, wherein the wireless resource requirement comprises one or more of the following: a spectrum requirement, a delay requirement, a reliability requirement, and a transmission rate requirement.

21. An electronic apparatus for wireless communications, comprising:
processing circuitry configured to:
acquire, from a first base station which UE is currently requesting to access or accessed in, information of a resource price of the first base station and the resource price of each base station within a set of candidate base stations, wherein the UE is capable of accessing the base station within the set of candidate base stations, and the resource price is determined based on information of a comparison between an overall wireless resource requirement of the UE of a base station and wireless resources that the base station is capable of providing; and
determine, based on at least the resource price, a second base station to access from among the set of candidate base stations, wherein the resource price of the second base station is lower than the resource price of the first base station.

22. The electronic apparatus according to claim 21, wherein the processing circuitry is configured to acquire information of the resource price in a broadcasting manner.

23. The electronic apparatus according to claim 21, wherein the processing circuitry is further configured to determine the second base station based on strength of a pilot signal of each base station.

24. The electronic apparatus according to claim 21, wherein the processing circuitry is configured to determine, from among the set of candidate base stations, a part of base stations each of which has a resource price lower than the resource price of the first base station, and, determine one of the part of base stations randomly as the second base station.

25. The electronic apparatus according to claim 24, wherein the processing circuitry is configured to determine to continue to access the first base station in a case that the resource price of the first base station is the lowest.

26. The electronic apparatus according to claim 21, wherein the processing circuitry is configured to determine the second base station based on an optimized foraging algorithm.

27. The electronic apparatus according to claim 21, wherein the processing circuitry is further configured to provide a wireless resource requirement of the user equipment to the first base station.

28. The electronic apparatus according to claim 21, wherein the wireless resource requirement comprises one or more of the following: a spectrum requirement, a delay requirement, a reliability requirement, and a transmission rate requirement.

29. A method for wireless communications, comprising:
determining, based on a comparison between an overall wireless resource requirement of user equipment (UE) accessing a base station within a predetermined region and wireless resources that the base station is capable of providing, a resource price of the base station; and
transmitting, to the base station, the resource price of the base station, so that the UE determines whether to access the base station based on at least the resource price.

30. A method for wireless communication, comprising:
acquiring, from UE accessed in a base station, an overall wireless resource requirement of the UE;
providing, to a spectrum management device, information of a comparison between the overall wireless resource requirement of the UE and wireless resources that the base station is capable of providing;
acquiring, from the spectrum management device, a resource price of the base station determined by the spectrum management device based on the information as well as the resource price of another base station determined by the spectrum management device; and
providing information of the resource price to the UE accessed in the base station.

31. A method for wireless communication, comprising:
acquiring, from a first base station UE is currently accessed in, information of a resource price of the first base station and the resource price of each base station within a set of candidate base stations, wherein the UE is capable of accessing a base station within the set of candidate base stations, and the resource price is determined based on information of a comparison between an overall wireless resource requirement of the UE of a base station and wireless resources that the base station is capable of providing; and
determining, based on at least the resource price, a second base station to access from among the set of candidate base stations, wherein the resource price of the second base station is lower than the resource price of the first base station.

32. A computer-readable storage medium having computer-executable instructions stored thereon, wherein the computer-executable instructions, when executed, cause the method for wireless communications according to any one of claims 29 to 31 to be performed.
